(19) United States
(12) Patent Application Publication
(10) Pub. No.: US 2022/0332351 A1
(43) Pub. Date: Oct. 20, 2022

(54) VEHICLE OPERATION SYSTEM

(71) Applicant: TOYOTA JIDOSHA KABUSHIKI KAISHA, Aichi-ken (JP)

(72) Inventors: Kosuke SAKAKIBARA, Toyota-shi (JP); Yoichi ONISHI, Okazaki-shi (JP); Kenji KANAMORI, Nagoya-shi (JP); Yusuke MATSUKAWA, Nagoya-shi (JP); Kei KAWASAKI, Kariya-shi (JP); Mahito OSUKA, Kariya-shi (JP); Keisuke SAITO, Kariya-shi (JP)

(21) Appl. No.: 17/723,476

(22) Filed: Apr. 19, 2022

(30) Foreign Application Priority Data
Apr. 20, 2021 (JP) 2021-070779

(51) Int. Cl. B60W 60/00; G08G 1/00; G06Q 50/30

(52) U.S. Cl. CPC B60W 60/0025; G08G 1/20; G06Q 50/30; B60W 2556/65

(57) ABSTRACT

Provided is a vehicle operation system including a first operation management server and a second operation management server. The first operation management server calculates a running route to the destination, a border point, and a scheduled arrival time at which the first vehicle is to arrive at the border point, and informs the second operation management server of these. Further, the first operation management server sends an operation instruction to the first vehicle to instruct it to run from the current position to the border point. The second operation management server sends an operation signal to a second vehicle to instruct it to arrive at the border point by the informed scheduled arrival time, and then to run from the border point to the destination after the user transfers from the first vehicle to the second vehicle at the border point.

### CROSS REFERENCE TO RELATED APPLICATION

This application claims priority to Japanese Patent Application No. 2021-070779 filed on Apr. 20, 2021, which is incorporated herein by reference in its entirety including the specification, claims, drawings, and abstract.

### TECHNICAL FIELD

The present disclosure relates to a vehicle operation system for autonomous driving vehicles that is operated within a predetermined operation area.

### BACKGROUND

A car sharing service has recently become popular in which registered member users share vehicles to use. A round trip type is a common service format for such a car sharing service in which a vehicle rented has to be returned to the same station as that where the vehicle has been rented. In addition, use of a one-way type service format has been recently increasing in which a vehicle rented can be returned to any station other than that where the vehicle has been rented (a predetermined parking lot). A car sharing service is operated within a predetermined service area, and the vehicles are required to stay within the service area.

For this requirement, the location of a vehicle is monitored based on the position information of the vehicle, which is regularly sent from a device mounted in the vehicle rented to a user. In order to address a case that a vehicle leaves the service area of the car sharing service, there has been suggested a method in which, in such a case, an alarm screen is displayed on a smartphone of the user with an alarm sound outputted from the smartphone, as disclosed in JP2015-69584A, for example.

### SUMMARY

According to the car sharing method disclosed in JP2015-69584A, users cannot go to destinations outside the predetermined service area, as the users are not allowed to use the vehicles when going outside of the predetermined service area.

Note here that a vehicle dispatch system including autonomous driving vehicles has been recently discussed. In such a system, the vehicles may be permitted to operate only within a predetermined administrative section, such as, cities, wards, towns, villages, and so forth. In such a case, users may not be allowed to use vehicles when going outside of the operation area.

To cope with the above, the present disclosure aims to enable users to use autonomous driving vehicles when going outside of the operation area.

According to one aspect of this disclosure, there is provided a vehicle operation system including: a first vehicle capable of autonomous driving and a second vehicle capable of autonomous driving; a first operation management server for communicating with the first vehicle in a first operation area to operate the first vehicle; and a second operation management server for communicating with the second vehicle in a second operation area adjacent to the first area to operate the second vehicle, and for communicating also with the first operation management server, wherein in the case that the destination of a user who gets in the first vehicle in the first operation area is located in the second operation area, the first operation management server calculates a running route to the destination, a border point between the first operation area and the second operation area on the way of the running route, and a scheduled arrival time at which the first vehicle is to arrive at the border point, based on the destination and the current position of the first vehicle, then informs the second operation management server of the destination, the running route, the border point, and the scheduled arrival time, and sends an operation instruction to the first vehicle to instruct it to run from the current position to the border point, and the second operation management server sends an operation instruction to the second vehicle to instruct it to arrive at the border point by the scheduled arrival time informed by the first operation management server, and to run from the border point to the destination after the user transfers from the first vehicle to the second vehicle at the border point.

With the above, a user can transfer autonomous driving vehicles at the border point between the first operation area and the second operation area, which enables the user to use an autonomous driving vehicle when going outside of the operation area.

According to another aspect of this disclosure, there is provided a vehicle operation system including: a first vehicle capable of autonomous driving and a second vehicle capable of autonomous driving; a first operation management server for communicating with the first vehicle in a first operation area to operate the first vehicle; and a second operation management server for communicating with the second vehicle in a second operation area adjacent to the first area to operate the second vehicle, and for communicating also with the first operation management server, wherein in the case that the destination of a user who gets in the first vehicle in the first operation area is located in the second operation area, the first operation management server calculates a running route to the destination, and a border point between the first operation area and the second operation area on the way of the running route, based on the destination and the current position of the first vehicle, then informs the second operation management server of the destination, the running route, and the border point, then sends an operation instruction to the first vehicle to instruct it to run from the current position to the border point, then obtains position information from the first vehicle, and sends a shift signal to the second management server to shift operation management of the first vehicle to the second management server when the first vehicle arrives at the border point, and upon receipt of the shift signal from the first operation management server, the second operation management server communicates with the first vehicle to manage the operation of the first vehicle.

As described above, switching the operation management servers for managing the operation of vehicles at the border point between the service areas enables a user to use an autonomous driving vehicle when going outside of the operation area.

In the disclosed vehicle operation system, the second operation management server may send an operation instruction to the first vehicle to instruct it to move back to the first operation area after completion of transport of the user, and the second operation management server obtains the position information from the first vehicle, and sends a shift signal to the first operation management server and the first vehicle to return the operation management of the first vehicle back to the first operation management server when the first vehicle arrives at the border point between the first operation area and the second operation area.

With the above, surplus and deficit in the number of vehicles managed by each operation management server in each operation area can be prevented.

The present disclosure enables users to use autonomous driving vehicles when going outside of an operation area.

### BRIEF DESCRIPTION OF DRAWINGS

Embodiment(s) of the present disclosure will be described based on the following figures, wherein:

FIG. 1 is a schematic block diagram illustrating the structure of a vehicle operation system in an embodiment;

FIG. 2 illustrates the data structure of an activation state database illustrated in FIG. 1;

FIG. 3 illustrates the data structure of a user database illustrated in FIG. 1:

FIG. 4 is a bock diagram illustrating the structure of a vehicle for use in the vehicle operation system according to the embodiment;

FIG. 5 is a control block diagram for the vehicle illustrated in FIG. 4;

FIG. 6 is a flowchart of the operation of the first operation management service illustrated in FIG. 1;

FIG. 7 is a flowchart of the operation of the second operation management service illustrated in FIG. 1;

FIG. 8 is a flowchart of another operation of the first operation management service illustrated in FIG. 1; and

FIG. 9 is a flowchart of another operation of the second operation management service illustrated in FIG. 1.

### DESCRIPTION OF EMBODIMENTS

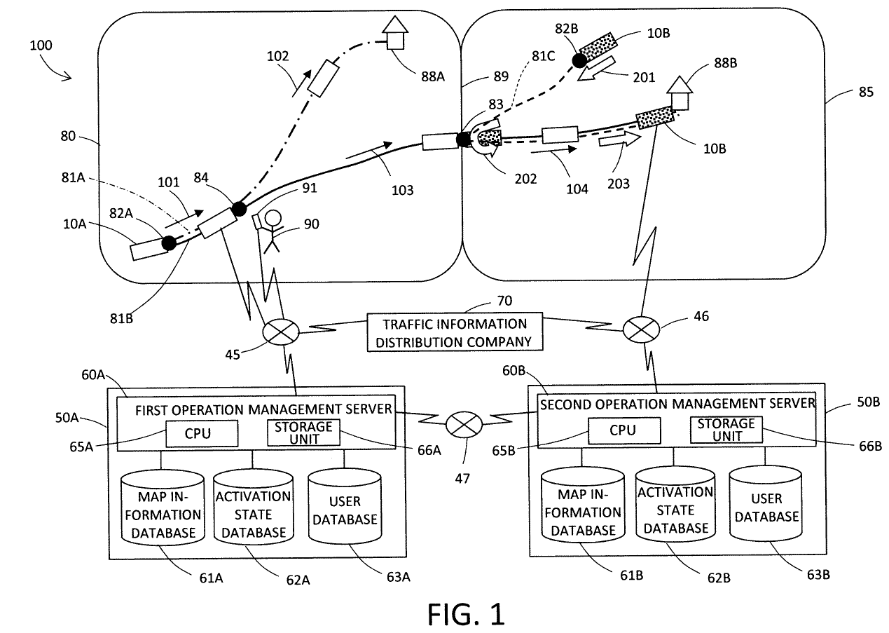

A vehicle operation system 100 according to an embodiment will now be described by reference to the following drawings. As illustrated in FIG. 1, the vehicle operation system 100 is composed of a first vehicle 10A capable of autonomous driving, a second vehicle 10B capable of autonomous driving, a first operation management server 60A, and a second operation management server 60B. The first vehicle 10A is connected to the first operation management server 60A via a radio communication line 45, while the second vehicle 10B is connected to the second operation management server 60B via a radio communication line 46. The first operation management server 60A is connected to the second operation management server 60B via a radio communication line 47. The first operation management server 60A and the second operation management server 60B are connected to a traffic information distribution company 70 via the radio communication lines 45, 46, respectively. The first operation management server 60A is connected to a portable terminal 91 carried by a user 90 via the radio communication line 45.

The first operation management server 60A and the second operation management server 60B are installed in a first operation management center 50A and a second operation management center 50B, respectively, to manage the respective operations of the first vehicle 10A and the second vehicle 10B within a first operation area 80 and a second operation area 85, respectively. The first operation area 80 and the second operation area 85 are located adjacent to each other along a border 89, and may be, for example, predetermined administrative sections, such as cities, wards, towns, or villages. Two or more first vehicles 10A and two or more second vehicles 10B may be operated within the first operation area 80 and the second operation area 85, respectively, although only one first vehicle 10A and one second vehicle 10B are illustrated in FIG. 1.

The first operation management server 60A is a computer incorporating a central processing unit, or CPU, 65A for information processing and a storage unit 66A for storing an operation program or the like, and is connected to a map information database 61A, an activation state database 62A, and a user database 63A. Similarly, the second operation management server 60B is a computer incorporating a CPU 65B for information processing and a storage unit 66B for storing an operation program or the like, and is connected to a map information database 61B, an activation state database 62B, and a user database 63B. Each of the map information databases 61A, 61B is a database containing map information.

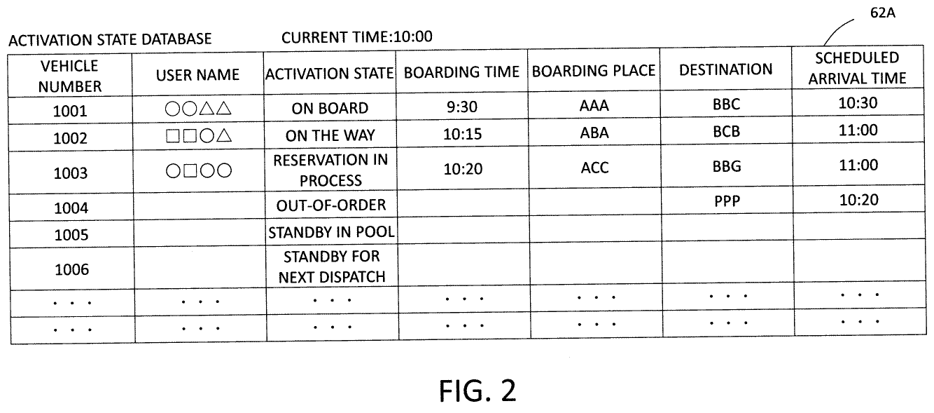

As illustrated in FIG. 2, the activation state database 62A is a database containing the vehicle numbers of a plurality of first vehicles 10A managed for operation by the first operation management server 60A, and also the current activation state, the name of a user 90, the boarding time at which the user 90 gets on board, the boarding place, the destination, and a scheduled arrival time, in relation to each of the first vehicles 10A in a mutually associated manner. Note that an activation state relates to the activation state of each first vehicle 10A, including, for example, “on board”, “on the way”, “reservation in process”, “out-of-service”, “standby in pool”, “standby for next dispatch”, and so forth. Specifically, “on board” refers to a state in which a user 90 is on board the first vehicle 10A and moving to a destination. “On the way” refers to a state in which the first vehicle 10A is moving to a place to pick up a user 90 in response to a request from the user 90. “Reservation in process” refers to a state in which the first vehicle 10A has been dispatched upon reservation by a user 90 and is standby until a time to start the service. “Out-of-service” refers to a state in which the first vehicle 10A is returning to a taxi pool or an operation station after completion of a service for a user 90. “Standby in pool” refers to a state in which the first vehicle 10A is fully charged for service and stands by in a taxi pool or an operation station. “Standby for next dispatch” refers to a state in which the first vehicle 10A has completed a service and is waiting for next dispatch. “A boarding time” refers to a time at which a user has gotten in the first vehicle 10A in the case where the user 90 is already on board by the current time, or a time at which a user is to get in the first vehicle 10A in the case where the user is to get on board after the current time. Similarly, a “boarding place” refers to a place where a user has actually gotten into or is to get into the first vehicle 10A. Note that “a boarding place” in the activation state database 62A is left blank with no boarding scheduled.

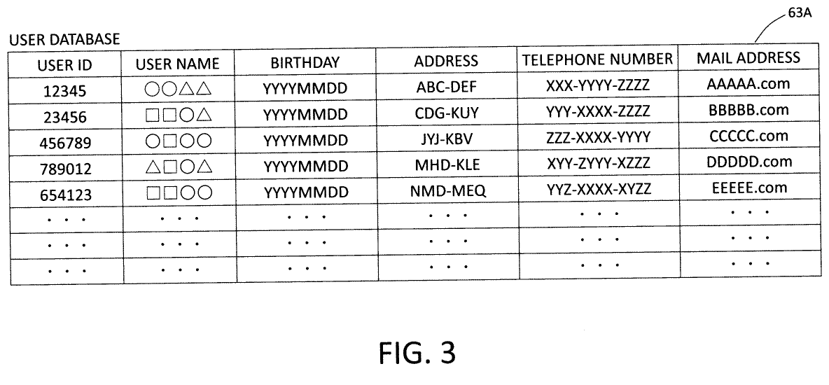

As illustrated in FIG. 3, the user database 63A is a database containing the user ID, name, birthday, address, telephone number, and mail address of a user 90 who is to use the first vehicle 10A, in a mutually associated manner.

The activation state database 62A and the user database 63A connected to the first operation management server 60A have been described above. The activation state database 62B connected to the second operation management server 60B has the same database structure as that of the activation state database 62A connected to the first operation management server 60A. Specifically, the activation state database 62B is a database containing the vehicle numbers of a plurality of second vehicles 10B to be managed for operation by the second operation management server 60B, and also the current activation state, a boarding time at which a user 90 has gotten or is to get on board, a boarding place, a destination, and a scheduled arrival time, for each vehicle in a mutually associated manner. The user database 63B connected to the second operation management server 60B has the same database structure as that of the user database 63A connected to the first operation management server 60A.

The first vehicle 10A is an autonomous driving taxi in operation in the first operation area 80. The second vehicle 10B is an autonomous driving taxi in operation in the second operation area 85 located adjacent to the first operation area 80.

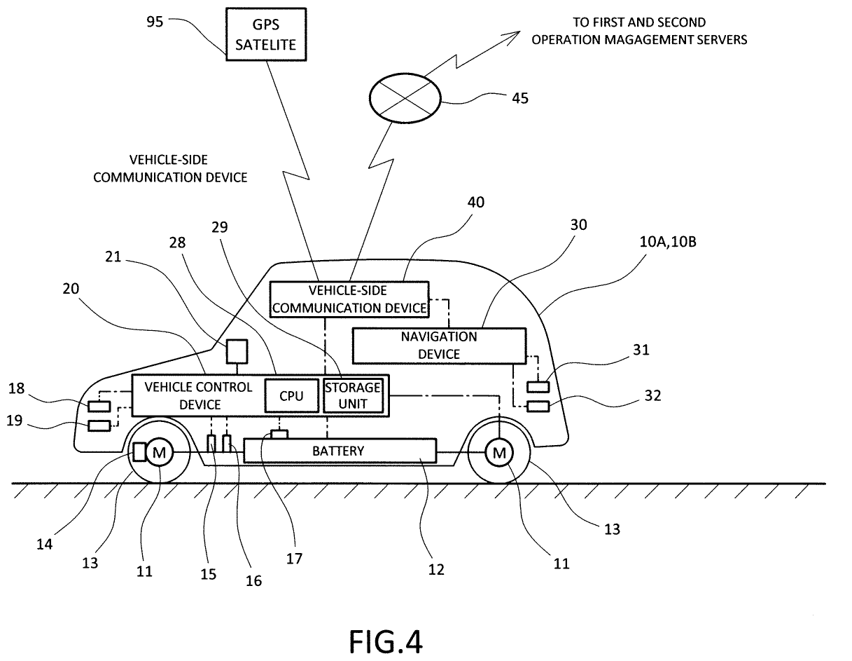

As illustrated in FIG. 4, the first vehicle 10A is an battery electric vehicle capable of autonomous driving, and includes a driving motor 11, a battery 12 for supplying driving power to the motor 11, a steering mechanism 14 for adjusting the yaw angles of wheels 13, a vehicle control device 20, a touch panel 21, a navigation device 30, and a vehicle-side communication device 40. The vehicle control device 20 is a computer incorporating a CPU 28 for information processing and a storage unit 29 for storing a software, a program, and data to be executed by the CPU 28. Similarly, the navigation device 30 also is a computer including a CPU and a storage unit.

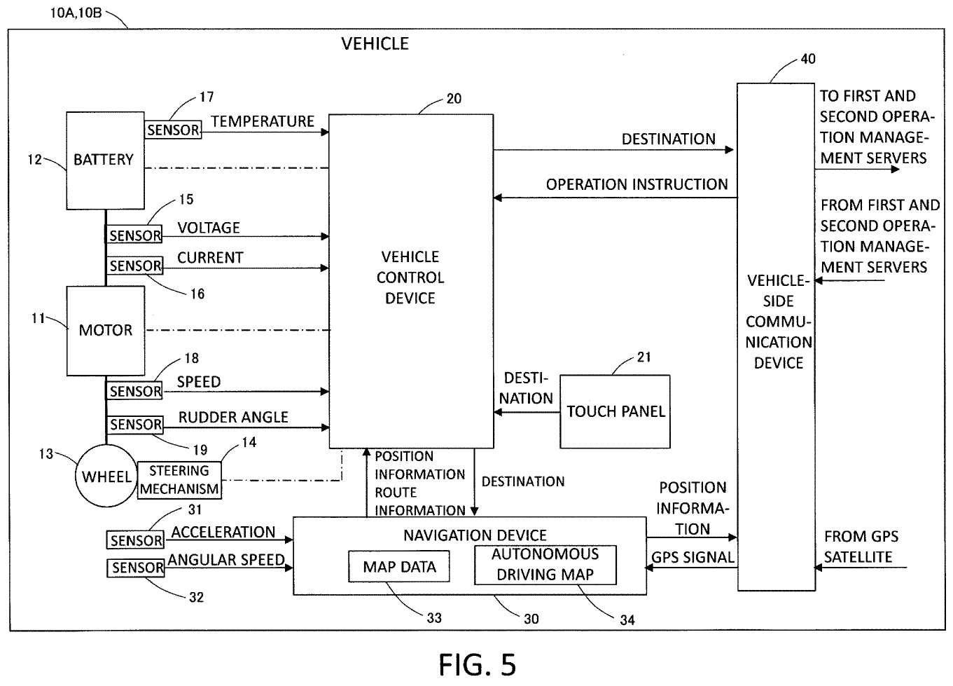

As illustrated in FIG. 5, the motor 11, the battery 12, the steering mechanism 14, and the touch panel 21 are connected to the vehicle control device 20. The touch panel 21 is disposed inside the vehicle cabin of the first vehicle 10A, and functions as an input device via which a user 90 on board the first vehicle 10A inputs a destination, for example, and also as a display device for displaying the state of the first vehicle 10A or a message received from the first operation management server 60A.

Between the battery 12 and the motor 11, a voltage sensor 15 and a current sensor 16 are installed for measuring the voltage and current of the power to be supplied from the battery 12 to the motor 11. The battery 12 has a temperature sensor 17 for measuring the temperature of the battery 12. Between the motor 11 and the wheels 13, a vehicle speed sensor 18 for measuring the speed of the vehicle and a yaw angle sensor 19 for measuring the yaw angle of the wheels 13 are installed. The voltage sensor 15, the current sensor 16, the temperature sensor 17, the vehicle speed sensor 18, and the yaw angle sensor 19 are connected to the vehicle control device 20.

The first vehicle 10A includes an acceleration sensor 31 and an angular speed sensor 32 for measuring the acceleration and the angular speed of the first vehicle 10A, respectively. The acceleration sensor 31 and the angular speed sensor 32 are connected to the navigation device 30. The navigation device 30 specifies the current position of the first vehicle 10A, based on a GPS signal received from a GPS satellite 95 via the vehicle-side communication device 40, and information on the acceleration and the yaw angle of the first vehicle 10A received from the acceleration sensor 31 and the angular speed sensor 32, respectively, and outputs the position information of the first vehicle 10A to the vehicle control device 20. In addition, the navigation device 30 incorporates map data 33 and an autonomous driving map 34. The navigation device 30 calculates a route to the destination, based on the current position and the destination inputted via the touch panel 21 or contained in an operation instruction received from the first operation management server 60A, and outputs route information to the vehicle control device 20. Further, the navigation device 30 outputs the current position information of the first vehicle 10A via the radio communication line 45 to the first operation management server 60A.

Based on the current position information and route information received from the navigation device 30 and the input data from the various sensors 15 to 19, the vehicle control device 20 controls the motor 11, the battery 12, and the steering mechanism 14 to autonomously run the first vehicle 10A.

The structure of the first vehicle 10A has been described above. The second vehicle 10B has the same structure as that of the first vehicle 10A. The second vehicle 10B is connected to the second operation management server 60B, and autonomously runs, following an operation instruction from the second operation management server 60B.

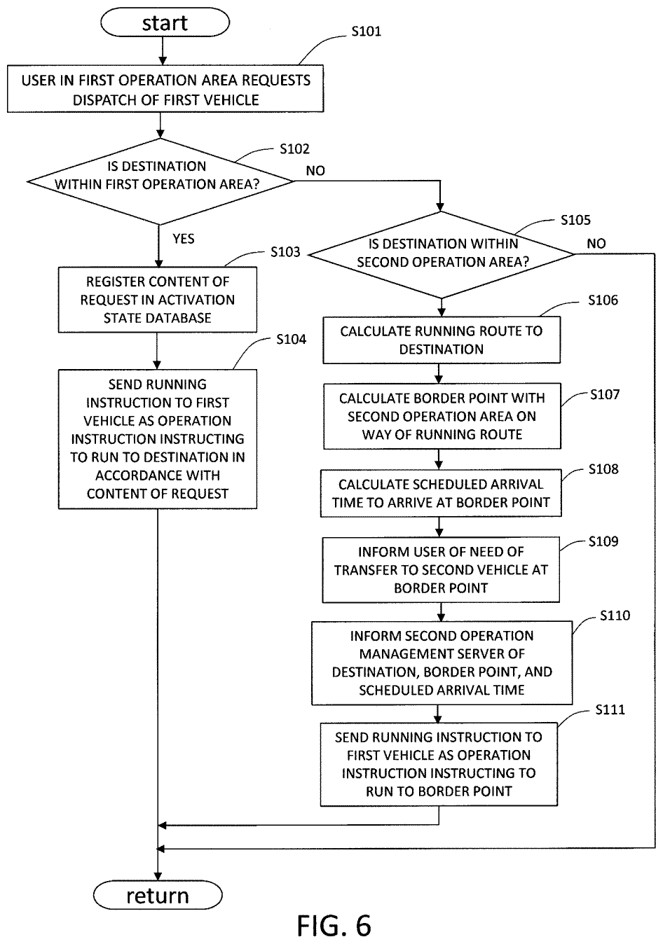

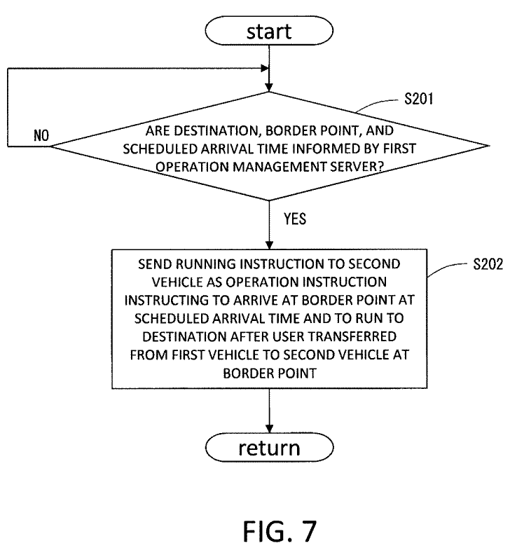

An operation of the vehicle operation system 100 will now be described by reference to FIG. 6 and FIG. 7. In S101 in FIG. 6, a user 90 in the first operation area 80 connects the portable terminal 91 to the first operation management server 60A, and inputs the ID of the user 90, the mail address, the destination, and a dispatch time, or the like, to request dispatch of a first vehicle 10A. Having received the dispatch request for a first vehicle 10A sent from the portable terminal 91 of the user 90, the first operation management server 60A verifies that the user 90 is a registered user 90, referring to the user database 63A. With verification, in step S102 in FIG. 6 the first operation management server 60A determines whether the destination is located within the first operation area 80. When YES is determined in step S102 in FIG. 6, in step S103 in FIG. 6 the first operation management server 60A registers the content of the dispatch request from the user 90 in the activation state database 62A. Then, in step S104 in FIG. 6 the first operation management server 60A sends to the first vehicle 10A a running instruction instructing to run to the destination in accordance with the content of the dispatch request as an operation instruction. In the case where the destination is located in the first operation area 80, the operation instruction contains the name of the user, a boarding place 84, the scheduled boarding time, and a destination 88A (refer to FIG. 1).

Having received the operation instruction, the first vehicle 10A inputs the scheduled boarding time, the boarding place 84, and the destination 88A into the navigation device 30 to obtain a running route 81A (refer to FIG. 1) to the destination 88A via the boarding place 84, from the navigation device 30. The first vehicle 10A starts running through autonomous driving from the current position 82A to the boarding place 84 along the running route 81A, as indicated with arrows 101, 102 in FIG. 1. Having started running to the boarding place 84, the first vehicle 10A sends to the first operation management server 60A a signal indicating that the activation state is now “on the way”. The first operation management server 60A registers the received activation state in the activation state database 62A.

When the first vehicle 10A arrives at the boarding place 84 and the user 90 gets in the first vehicle 10A, the first vehicle 10A sends to the first operation management server 60A a signal indicating that the activation state is now “on-board” and a scheduled arrival time at which the first vehicle 10A is to arrive at the destination 88A. The first operation management server 60A registers the received activation state in the activation state database 62A. When the first vehicle 10A runs along the running route 81A and arrives at the destination 88A and the user 90 gets off the first vehicle 10A, the first vehicle 10A sends to the first operation management server 60A a signal indicating that the operation for the reservation by the user 90 is completed and the first vehicle 10A is now on “standby for next dispatch”. The first operation management server 60A registers the received activation state in the activation state database 62A.

In contrast, when NO is determined in step S102 in FIG. 6, in step S105 in FIG. 6 the first operation management server 60A determines whether the destination 88B is located within the second operation area 85. When YES is determined in S105 in FIG. 6, in step S106 in FIG. 6 the first operation management server 60A calculates a running route 81B (refer to FIG. 1) from the current position of the first vehicle 10A in the first operation area 80 via the boarding place 84 to the destination 88B in the second operation area 85, based on the current position information received from the first vehicle 10A, the boarding place 84, and the destination 88B, by referring to the map information database 61A. Then, in step S107 in FIG. 6 the first operation management server 60A calculates a border point 83 between the first operation area 80 and the second operation area 85 on the way of the calculated running route 81B. Then, in step S108 in FIG. 6 the first operation management server 60A obtains the traffic condition of the running route from the traffic information distribution company 70, and calculates a scheduled arrival time at which the first vehicle 10A is to arrive at the border point 83.

Then, in step S109 in FIG. 6 the first operation management server 60A informs the user 90 that the user 90 needs to transfer to the second vehicle 10B at the border point 83. Further, in step S110 in FIG. 6 the first operation management server 60A sends to the second operation management server 60B information on the destination 88B of the first vehicle 10A, the border point 83 on the way of the running route 81B, and the scheduled arrival time at which the first vehicle 10A is to arrive at the border point 83at. Further, in step S111 in FIG. 6 the first operation management server 60A sends to the first vehicle 10A a running instruction instructing to run to the border point 83 as an operation instruction at. This operation instruction contains the name of the user, the boarding place 84, the scheduled boarding time, the border point 83, and a running route to the border point 83.

Having received the operation instruction, the first vehicle 10A inputs into the navigation device 30 the boarding place 84, the scheduled boarding time, the border point 83, and the running route 81B to the border point 83. Then, the first vehicle 10A runs to the boarding place 84 along the running route 81B informed by the first operation management server 60A, as indicated with the arrow 101 in FIG. 1, based on the route information received from the navigation device 30, to pick up the user 90, and thereafter runs to the border point 83, as indicated with the arrow 103 in FIG. 1.

When the first vehicle 10A arrives at the boarding place 84 and the user 90 gets in the first vehicle 10A, the first vehicle 10A sends to the first operation management server 60A a signal indicating that the activation state is now “on board”. The first operation management server 60A registers the received activation state in the activation state database 62A. When the first vehicle 10A arrives at the border point 83 and the user 90 gets off the first vehicle 10A, the first vehicle 10A sends to the first operation management server 60A a signal indicating that the operation relevant to the operation instruction is completed and that the first vehicle 10A is now on “standby for next dispatch”. The first operation management server 60A registers the received activation state in the activation state database 62A.

Meanwhile, in step S201 in FIG. 7 the second operation management server 60B waits for receipt of the information on the destination 88B of the first vehicle 10A, the border point 83 on the way of the running route 81B, and the scheduled arrival time at which the first vehicle 10A is to arrive at the border point 83 sent from the first operation management server 60A at.

Upon receipt of the information on the destination 88B or the like from the first operation management server 60A, the second operation management server 60B determines YES in step S201 in FIG. 7, and then in step S202 in FIG. 7 sends a running instruction to the second vehicle 10B as an operation instruction, instructing to arrive at the border point 83 by the scheduled arrival time and then run to the destination 88 after the user 90 transfers from the first vehicle 10A to the second vehicle 10B at the border point 83.

Having received the operation instruction, the second vehicle 10B inputs the border point 83, a scheduled arrival time at which the first vehicle 10A is to arrive at the border point 83, and the destination 88B in the navigation device 30, and then receives a running route 81C to the destination 88B via the border point 83 from the navigation device 30. The second vehicle 10B starts running through autonomous driving from the current position 82B to the border point 83, as indicated with the white arrow 201 in FIG. 1.

After starting running to the border point 83, the second vehicle 10B sends to the second operation management server 60B a signal indicating that the activation state is now “on the way”. The second operation management server 60B registers the received activation state in the activation state database 62B. When the second vehicle 10B arrives at the border point 83 and the user 90 having gotten off the first vehicle 10A gets in the second vehicle 10B, the second vehicle 10B sends to the second operation management server 60B a signal indicating that the activation state is now “on board”. The second operation management server 60B registers the received activation state in the activation state database 62B. Then, the second vehicle 10B starts running from the border point 83 along the running route 81C to the destination 88B, as indicated with the white arrows 202, 203 in FIG. 1. When the second vehicle 10B arrives at the destination 88B and the user 90 gets off the second vehicle 10B, the second vehicle 10B sends to the second operation management server 60B a signal indicating that the operation relevant to the operation instruction is completed and that the second vehicle 10B is now on “standby for next dispatch”. The second operation management server 60B registers the received activation state in the activation state database 62B.

As described above, the vehicle operation system 100 according to this embodiment, as the user 90 can transfer from the first vehicle 10A to the second vehicle 10B at the border point 83, the user 90 can use an autonomous driving vehicle when going outside of the operation area also in the case where the operation of the first vehicle 10A is restricted to only inside the first operation area 80 and that of the second vehicle 10B is restricted to only inside the second operation area 85 due to administrative division.

Note that in the case NO is determined in step S105 in FIG. 6, the first operation management server 60A ends the procedure without dispatching the first vehicle 10A.

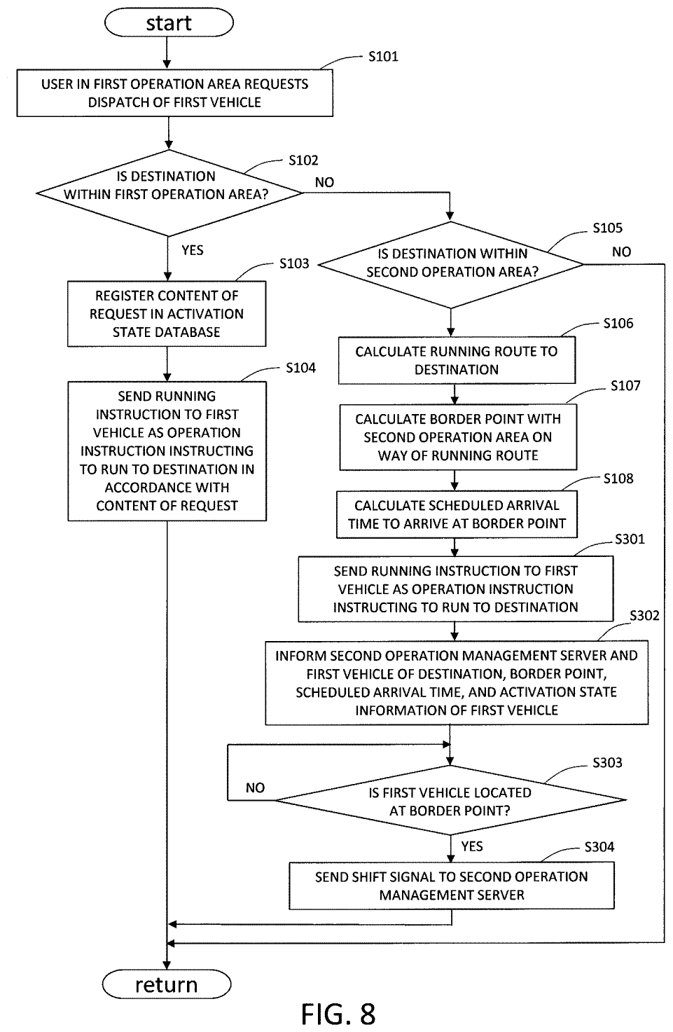

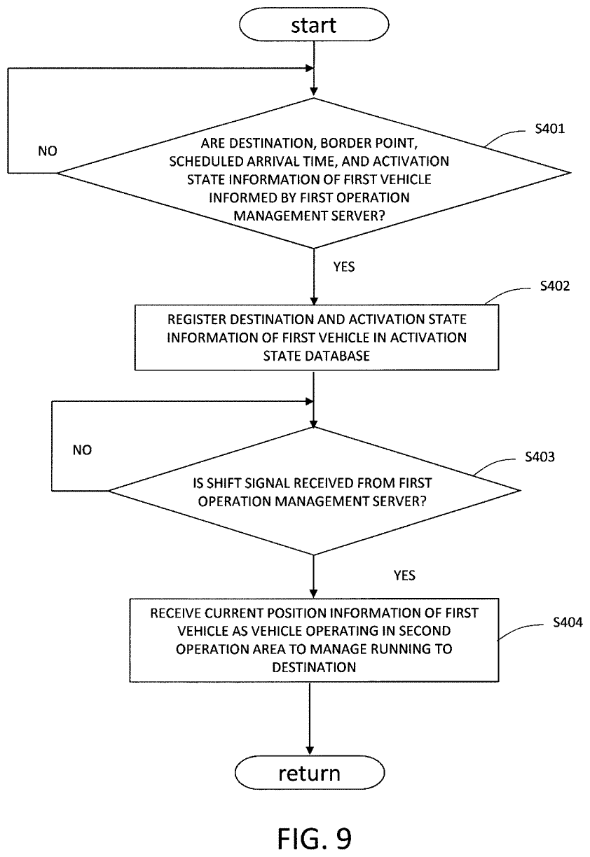

Another operation of the vehicle operation system 100 according to this embodiment will now be described referring to FIG. 8 and FIG. 9. The same processes as those which have been described above by reference to FIG. 6 and FIG. 7 are given the same reference signs, and are not described again.

According to the embodiment illustrated in FIGS. 8 and 9, the operation management of the first vehicle 10A is shifted from the first operation management server 60A to the second operation management server 60B, so that the user 90 can use an autonomous driving vehicle when going outside of the operation area.

In the case where the destination 88B of the user 90 in the first operation area 80 is located within the second operation area 85, in steps S106 to S108 in FIG. 8 the first operation management server 60A calculates the running route 81B to the destination 88B, the border point 83, and a scheduled arrival time at which the first vehicle 10A is to arrive at the border point 83. Then, in step S301 in FIG. 8 the first operation management server 60A sends a running instruction to the first vehicle 10A as an operation instruction, instructing it to run to the destination 88B in accordance with the content of the request from the user 90. The operation instruction contains the name of the user, the boarding place 84, the scheduled boarding time, and the destination 88B.

When the first vehicle 10A arrives at the boarding place 84 and the user 90 gets in the first vehicle 10A, the first vehicle 10A sends to the first operation management server 60A a signal indicating that the activation state is now “on-board”, and informs the first operation management server 60A of the scheduled arrival time at which the first vehicle 10A is to arrive at the destination 88B. The first operation management server 60A registers the received activation state in the activation state database 62A.

Further, in step S302 in FIG. 8 the first operation management server 60A sends to the second operation management server 60B information on the destination 88B, the border point 83, the scheduled arrival time at which the first vehicle 10A is to arrive at the border point 83, and the activation state information of the first vehicle 10A contained in the activation state database 62Aat. The activation state information of the first vehicle 10A contains the vehicle number of the first vehicle 10A, the name of the current user, the activation state, the boarding time, the boarding place 84, and the scheduled arrival time, contained in the activation state database 62A. The first operation management server 60A receives the current position information from the first vehicle 10A in step S303 in FIG. 8, and stays on standby until the first vehicle 10A arrives at the border point 83. When the first vehicle 10A arrives at the border point 83, the first operation management server 60A determines YES in step S303 in FIG. 8, and then in step S304 in FIG. 8 sends a shift signal to the second operation management server 60B and the first vehicle 10A. Having received the shift signal, the first vehicle 10A switches the receiver of the current position information and activation state information to be sent from the first operation management server 60A to the second operation management server 60B, and runs along the running route 81B toward the destination 88B in the second operation area 85, as indicated with an arrow 104 in FIG. 1.

Meanwhile, the second operation management server 60B waits for receipt of the information on the destination 88B, the border point 83, the scheduled arrival time at which the first vehicle 10A is to arrive at the border point 83, and the activation state information of the first vehicle 10A, sent from the first operation management server 60A. Having received the information, the second operation management server 60B determines YES in step S401 in FIG. 9, and in step S402 in FIG. 9 registers the destination 88B and the current activation state information of the first vehicle 10A in the activation state database 62B. In this case, the second operation management server 60B creates a row for the vehicle number of the first vehicle 10A in the activation state database 62B, and registers the vehicle number of the first vehicle 10A, the name of the current user, the activation state, the boarding time, the boarding place 84, and the destination 88B therein. Further, the second operation management server 60B stores in the storage unit 66B the border point 83 and the scheduled arrival time at which the first vehicle 10A is to arrive at the border point 83.

In step S403 in FIG. 9 the second operation management server 60B waits for receipt of the shift signal sent from the first operation management server 60A. Having received the shift signal, in step S404 in FIG. 9 the second operation management server 60B receives the current position information of the first vehicle 10A as a vehicle in operation in the second operation area 85, to manage the running of the first vehicle 10A to the destination 88B.

When the first vehicle 10A arrives at the destination 88B and the user 90 gets off the first vehicle 10A, the first vehicle 10A sends to the second operation management server 60B a signal indicating that the operation relevant to the reservation by the user 90 is completed and that the first vehicle 10A is now on “standby for next dispatch”. The second operation management server 60B registers the received activation state in the activation state database 62B.

After the transport of the user 90 is completed, the second operation management server 60B sends an operation instruction to the first vehicle 10A, instructing it to move back to the first operation area 80. Then, the second operation management server 60B receives the current position information from the first vehicle 10A, and then waits for arrival of the first vehicle 10A at the border point 83. When the first vehicle 10A arrives at the border point 83 between the first operation area 80 and the second operation area 85, the second operation management server 60B sends a return signal to the first operation management server 60A and the first vehicle 10A to return the operation management of the first vehicle 10A back to the first operation management server 60A. Note that the return signal may be sent at any time when the first vehicle 10A is located anywhere on the border 89 between the first operation area 80 and the second operation area 85, not necessarily at the border point 83.

Having received the return signal, the first vehicle 10A switches the receiver of the current position information and the activation state information to be sent from the second operation management server 60B to the first operation management server 60A. Having received the return signal from the second operation management server 60B, the first operation management server 60A receives the current position information of the first vehicle 10A, and thereafter manages the operation of the first vehicle 10A.

As described above, according to the vehicle operation system 100 in this embodiment, the user 90 can use an autonomous driving vehicle when going outside of the operation area also in the case that the first operation management server 60A and the second operation management server 60B are restricted, due to regulation, to be able to manage the operations of vehicles only inside the first operation area 80 and the second operation area 85, respectively. Further, as the first vehicle 10A is returned to the first operation area 80 and the operation management of the first vehicle 10A is returned from the second operation management server 60B to the first operation management server 60A after completion of transport of the user 90, it is possible to prevent the surplus or deficit in the number of vehicles managed by the first operation management server 60A and the second operation management server 60B in the first operation area 80 and the second operation area 85, respectively.

Although it is described in the above that the first operation management server 60A receives a dispatch request containing the destination 88 sent from the user 90 via the portable terminal 91, this is not an exclusive example. For example, the user 90 may get on board a first vehicle 10A and then input the destination 88A, 88B via the touch panel 21. In this case, the first vehicle 10A sends information on the inputted destination 88A, 88B to the first operation management server 60A, and the first operation management server 60A then determines whether the destination 88A, 88B is within the first operation area 80 or within the second operation area 85.

Although it is described in the above that the first vehicle 10A and the second vehicle 10B are autonomous driving taxies, the first vehicle 10A and the second vehicle 10B may be autonomous driving sharing vehicles instead, not necessarily autonomous driving taxies. In this case, a user 90 on board the first vehicle 10A inputs the destination 88A, 88B via the touch panel 21, and the first vehicle 10A then informs the first operation management server 60A of the destination 88A, 88B, so that the first operation management server 60A determines whether the destination 88A, 88B is within the first operation area 80 or within the second operation area 85. An operation thereafter is the same as that described by reference to FIG. 6 to FIG. 9.

Although it is described in the above that the first vehicle 10A and the second vehicle 10B are autonomous driving electric vehicles, the first vehicle 10A and the second vehicle 10B may be autonomous driving engine-driven vehicles, not necessarily electric vehicles.

Although it is described in the above that the user 90 transfers from the first vehicle 10A to the second vehicle 10B at the border point 83 between the first operation area 80 and the second operation area 85 on the way of the running route 81B, this is not an exclusive place for transfer. For example, if there is a parking lot, for example, available near the border point 83, the first vehicle 10A and the second vehicle 10B may run to the parking lot near the border point 83, so that the user 90 can transfer from the first vehicle 10A to the second vehicle 10B in the parking lot. This ensures safer transport of the user 90. In another example, if there is a hotel entrance, a porch, or the like, for example, where rain can be kept off near the border point 83, the first vehicle 10A and the second vehicle 10B may run to such a place so that the user 90 transfers from the first vehicle 10A to the second vehicle 10B there. This can keep the rain off the user 90 when the user 90 is transferring.

1. A vehicle operation system, comprising:
a first vehicle capable of autonomous driving and a second vehicle capable of autonomous driving;
a first operation management server for communicating with the first vehicle in a first operation area to operate the first vehicle; and
a second operation management server for communicating with the second vehicle in a second operation area adjacent to the first area to operate the second vehicle, and for communicating also with the first operation management server,
wherein
in a case where a destination of a user who gets in the first vehicle in the first operation area is located in the second operation area, the first operation management server calculates a running route to the destination, a border point between the first operation area and the second operation area on a way of the running route, and a scheduled arrival time at which the first vehicle is to arrive at the border point, based on the destination and a current position of the first vehicle, then informs the second operation management server of the destination, the running route, the border point, and the scheduled arrival time, and sends an operation instruction to the first vehicle to instruct it to run from the current position to the border point, and
the second operation management server sends an operation instruction to the second vehicle to instruct it to arrive at the border point by the scheduled arrival time informed by the first operation management server, and to run from the border point to the destination after the user transfers from the first vehicle to the second vehicle at the border point.

2. A vehicle operation system, comprising:
a first vehicle capable of autonomous driving and a second vehicle capable of autonomous driving;
a first operation management server for communicating with the first vehicle in a first operation area to operate the first vehicle; and
a second operation management server for communicating with the second vehicle in a second operation area adjacent to the first area to operate the second vehicle, and for communicating also with the first operation management server,
wherein
in a case where a destination of a user who gets in the first vehicle in the first operation area is located in the second operation area, the first operation management server calculates a running route to the destination and a border point between the first operation area and the second operation area on a way of the running route, based on the destination and a current position of the first vehicle, then informs the second operation management server of the destination, the running route, and the border point, then sends an operation instruction to the first vehicle to instruct to run from the current position to the border point, then obtains position information from the first vehicle, and sends a shift signal to the second management server to shift operation management of the first vehicle to the second management server when the first vehicle arrives at the border point, and
upon receipt of the shift signal from the first operation management server, the second operation management server communicates with the first vehicle to manage operation of the first vehicle.

3. The vehicle operation system according to claim 2, wherein
the second operation management server sends an operation instruction to the first vehicle to instruct to move back to the first operation area after completion of transport of the user, and
the second operation management server obtains the position information from the first vehicle, and sends a shift signal to the first operation management server and the first vehicle to return the operation management of the first vehicle back to the first operation management server when the first vehicle arrives at the border point between the first operation area and the second operation area.
